(19) United States
(12) Patent Application Publication
(10) Pub. No.: US 2026/0195355 A1
(43) Pub. Date: Jul. 9, 2026

(54) METHOD, APPARATUS, DEVICE, STORAGE MEDIUM AND PROGRAM PRODUCT FOR QUERY

(71) Applicant: Beijing Zitiao Network Technology Co., Ltd., Beijing (CN)

(72) Inventors: Yifan DING, Beijing (CN); Ziyang ZHENG, Beijing (CN); Siyu LIU, Beijing (CN)

(21) Appl. No.: 19/443,921

(22) Filed: Jan. 8, 2026

(30) Foreign Application Priority Data
Jan. 9, 2025 (CN) 202510038425.X

(51) Int. Cl. G06F 16/3329; G06F 9/451

(52) U.S. Cl. CPC G06F 16/33295; G06F 9/451

(57) ABSTRACT

The disclosure provides a method, an apparatus, a device, a storage medium, and a program product for query. In one method, first media data is obtained by a first acquisition device of a terminal device. Second media data is obtained by a second acquisition device of the terminal device, in response to determining that the second media data needs to be obtained, the determination is based on the first media data and a query. A reply for the query is provided based on the first media data and the second media data.

### CROSS-REFERENCE

The present application claims priority to Chinese Patent Application No. 202510038425.X, filed on January 9, 2025, and entitled "METHOD, APPARATUS, DEVICE, STORAGE MEDIUM AND PROGRAM PRODUCT FOR QUERY", which is incorporated herein by reference in its entirety.

### FIELD

Example embodiments of the present disclosure generally relate to the field of computers, and in particular, to a method, an apparatus, an electronic device, a computer-readable storage medium, and a computer program product for query.

### BACKGROUND

With the development of information technologies, various terminal devices may provide people with various services in aspects such as work and life. For example, an application providing a service may be deployed in a terminal device. The terminal device or the application may provide a user with a type of digital assistant function to assist the user in using the terminal device or the application. The user may query desired information through various interactions with the digital assistant.

### SUMMARY

In a first aspect of the present disclosure, a query method is provided. The method includes: obtaining first media data by a first acquisition device of a terminal device; obtaining second media data by a second acquisition device of the terminal device, in response to determining that the second media data needs to be obtained, the determination being based on the first media data and a query; and providing a reply for the query based on the first media data and the second media data.

In a second aspect of the present disclosure, an apparatus for query is provided. The apparatus includes: a first obtaining module configured to obtain first media data by a first acquisition device of a terminal device; a second obtaining module configured to obtain second media data by a second acquisition device of the terminal device, in response to determining that the second media data needs to be obtained, the determination is based on the first media data and a query; and a provision module configured to provide a reply for the query based on the first media data and the second media data.

In a third aspect of the present disclosure, an electronic device is provided. The electronic device includes at least one processor and at least one memory; the at least one memory is coupled to the at least one processor, and stores instructions executable by the at least one processor, and the instructions, when executed by the at least one processor, cause the electronic device to perform the method of the first aspect.

In a fourth aspect of the present disclosure, a computer-readable storage medium is provided. The computer-readable storage medium stores a computer program, the computer program, when executed by a processor, causes the processor to perform the method of the first aspect.

In a fifth aspect of the present disclosure, a computer program product is provided. The computer program product is tangibly stored in a computer storage medium, and includes computer-executable instructions, the computer-executable instructions, when executed by a device, cause the device to perform the method of the first aspect.

It should be understood that content described in the content part of the present disclosure is not intended to limit key features or important features of the embodiments of the present disclosure, and is also not intended to limit the scope of the present disclosure. Other features of the present disclosure will become readily comprehensible through the following description.

### BRIEF DESCRIPTION OF THE DRAWINGS

The foregoing and other features, advantages, and aspects of the embodiments of the present disclosure become more apparent with reference to the following detailed description and in conjunction with the drawings. In the drawings, the same or similar reference numerals denote the same or similar elements.

FIG. 1A illustrates a schematic diagram of an example environment in which the embodiments of the present disclosure may be implemented;

FIG. 1B illustrates a schematic diagram of a process for query according to some embodiments of the present disclosure;

FIG. 1C illustrates a schematic diagram for media data acquisition according to some embodiments of the present disclosure;

FIG. 1D illustrates a schematic diagram for media data acquisition from an application running at a terminal device according to some embodiments of the present disclosure;

FIG. 2A to FIG. 2H illustrate example interfaces according to some embodiments of the present disclosure;

FIG. 3 illustrates an example according to some embodiments of the present disclosure;

FIG. 4 illustrates a flowchart of a method for query according to some embodiments of the present disclosure;

FIG. 5 illustrates an example structural block diagram of an apparatus for query according to some embodiments of the present disclosure; and

FIG. 6 illustrates a block diagram of an electronic device in which one or more embodiments of the present disclosure may be implemented.

### DETAILED DESCRIPTION

Embodiments of the present disclosure are described in more detail below with reference to the drawings. Although some embodiments of the present disclosure are shown in the drawings, it should be understood that the present disclosure may be implemented in various forms, and should not be construed as being limited to the embodiments set forth herein. Instead, these embodiments are provided for a more thorough and complete understanding of the present disclosure. It should be understood that the drawings and the embodiments of the present disclosure are only for illustrative purposes, and are not intended to limit the protection scope of the present disclosure.

In the description of the embodiments of the present disclosure, the term "include/comprise" and similar terms thereof should be understood as open-ended inclusions, that is, "include/comprise but not limited to". The term "based on" should be understood as "at least partially based on". The term "an embodiment" or "the embodiment" should be understood as "at least one embodiment". The term "some embodiments" should be understood as "at least some embodiments". The following may further include other explicit and implicit definitions.

In this specification, unless explicitly stated, "performing a step in response to A" does not mean that the step is performed immediately after "A", and one or more intermediate steps may be included.

It may be understood that the data involved in the technical solution (including but not limited to the data itself, acquisition, use, storage or deletion of the data) should comply with requirements of corresponding laws, regulations, and related provisions.

It may be understood that before the use of the technical solution disclosed in the embodiments of the present disclosure, a user shall be informed of the type, range of use, use scenarios, etc., of personal information involved in the present disclosure, and the authorization of the user shall be obtained, in an appropriate manner in accordance with relevant laws and regulations.

For example, in response to reception of an active request from a user, prompt information is sent to the user to clearly inform the user that the requested operation will require access to and use of the personal information of the user, so that the user may independently choose, based on the prompt information, whether to provide the personal information to software or hardware, such as an electronic device, an application, a server, or a storage medium, that performs the operations of the technical solution of the present disclosure.

As an optional but non-restrictive implementation, in response to the reception of the active request from the user, the prompt information may be sent to the user in the form of, for example, a pop-up window, in which the prompt information may be presented in text. Furthermore, the pop-up window may also include a selection control for the user to choose whether to "agree" or "disagree" to provide the personal information to the electronic device.

It may be understood that the above process of notifying and obtaining user authorization is only illustrative, and does not limit the implementations of the present disclosure. Other manners that satisfy the relevant laws and regulations may also be applied in the implementations of the present disclosure.

As used herein, the term "model" may learn a correlation between respective inputs and outputs from training data, so that a corresponding output may be generated for a given input after the training is completed. The generation of the model may be based on machine learning techniques. Deep learning is a machine learning algorithm that uses multiple layers of processing units to process inputs and provide corresponding outputs. A neural network model is an example of a model based on deep learning. Herein, a "model" may also be referred to as a "machine learning model", a "learning model", a "machine learning network", or a "learning network", which terms are used interchangeably herein.

A "neural network" is a machine learning network based on deep learning. The neural network may process an input and provide a corresponding output, and typically includes an input layer and an output layer, and one or more hidden layers between the input layer and the output layer. The neural network used in deep learning applications typically includes many hidden layers to increase the depth of the network. The layers of the neural network are connected in sequence, so that an output of a previous layer is provided as an input of a next layer, where the input layer receives the input of the neural network, and an output of the output layer serves as a final output of the neural network. Each layer of the neural network includes one or more nodes (also referred to as processing nodes or neurons), and each node processes an input from the previous layer.

Generally, machine learning may roughly include three stages, namely, a training stage, a testing stage, and an application stage (also referred to as an inference stage). In the training stage, a given model may be trained using a large amount of training data, and a parameter value may be continuously iteratively updated until the model may obtain consistent inference that meets an expected objective from the training data. Through training, the model may be considered to be able to learn a correlation (also referred to as a mapping from the input to the output) from an input to an output from the training data. The parameter value of the trained model is determined. In the testing stage, a test input is applied to the trained model to test whether the model may provide a correct output, thereby determining the performance of the model. The testing stage may sometimes be incorporated into the training stage. In the application or inference stage, the trained model may be used to process an actual model input based on the parameter value obtained through training, to determine a corresponding model output.

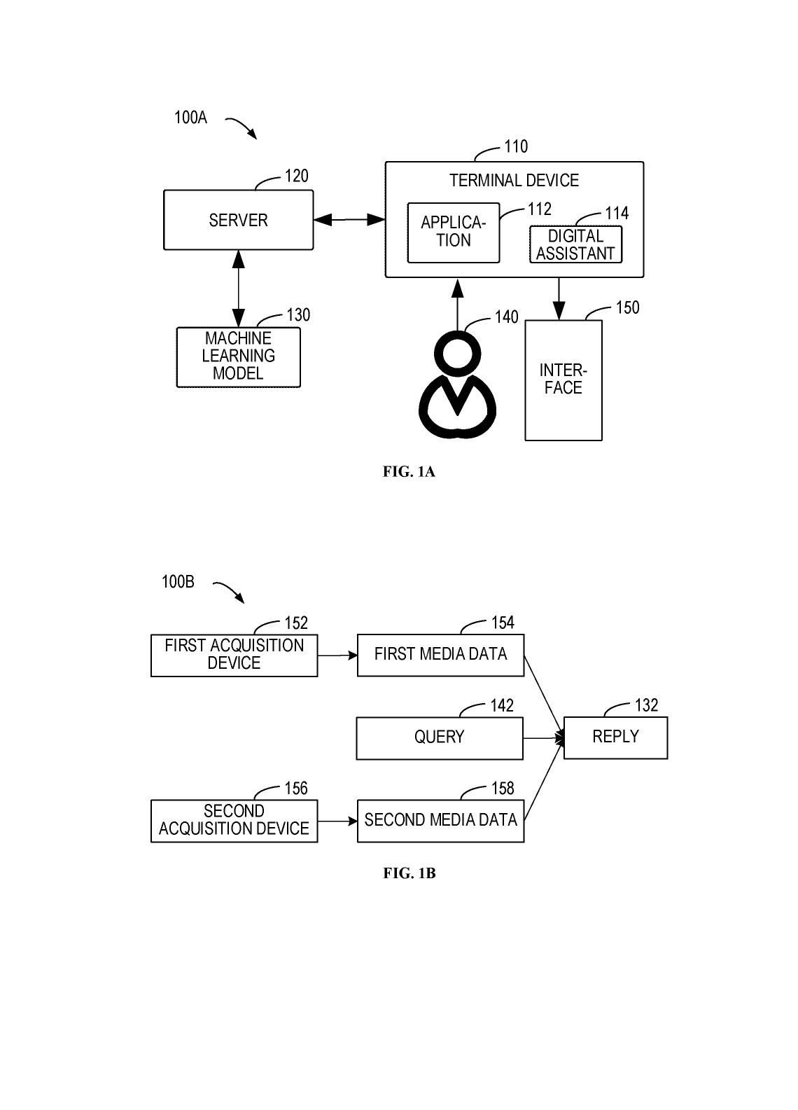

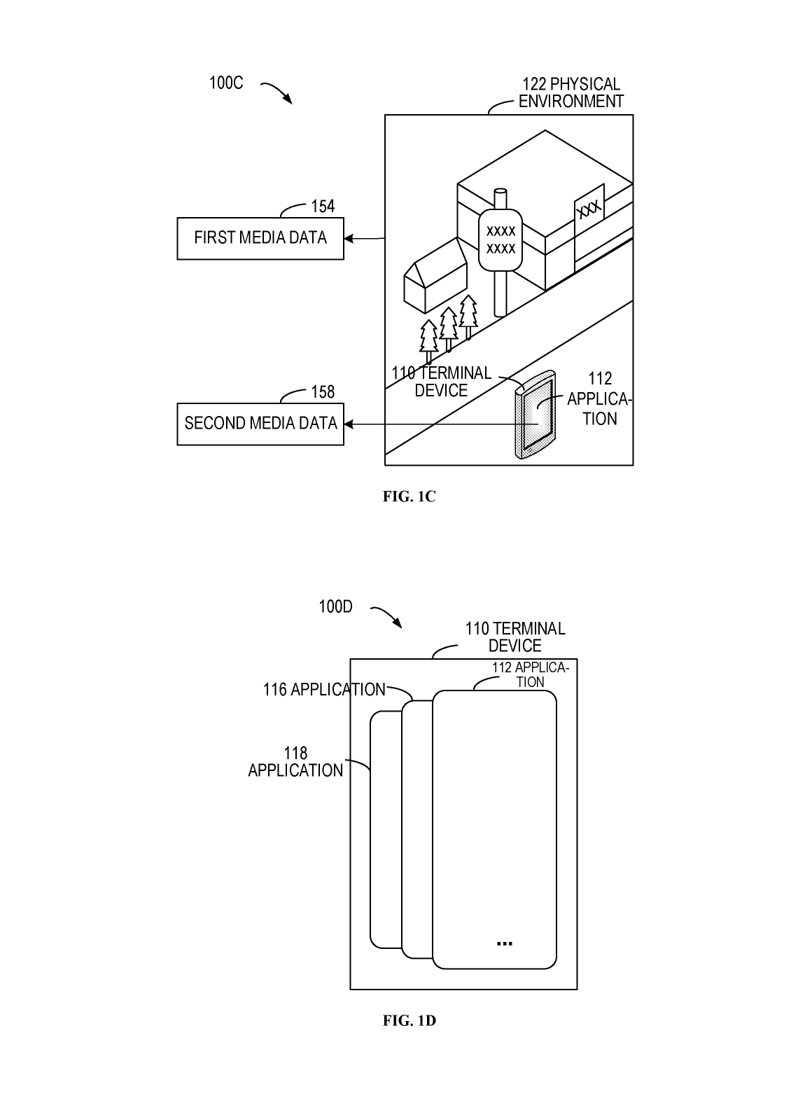

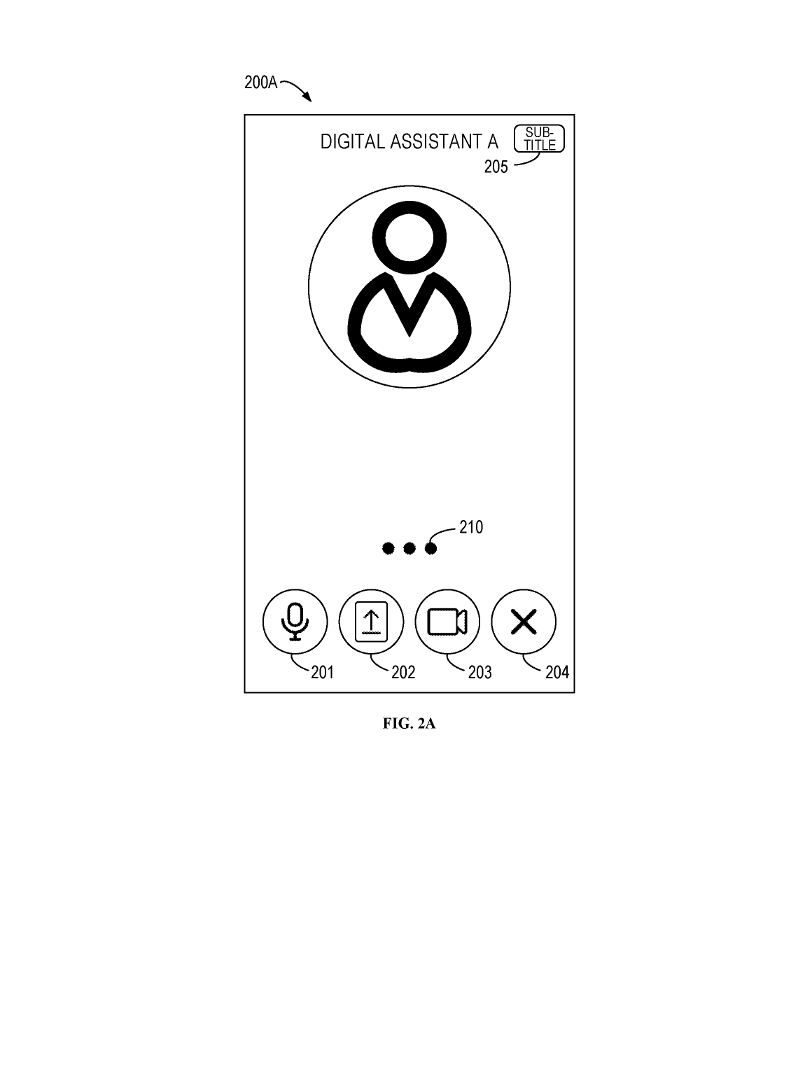

FIG. 1A is a schematic diagram of an example environment 100A in which the embodiments of the present disclosure may be implemented. In the example environment 100A, an application 112 and a digital assistant 114 are installed in a terminal device 110. A user 140 may interact with the application 112 via the terminal device 110 and/or an attachment device of the terminal device 110. In some implementations, the application 112 may be authorized to acquire a speech via a microphone of the terminal device 110, acquire an image via a camera of the terminal device 110, and so on.

In some embodiments, the application 112 and the digital assistant 114 may be downloaded and installed on the terminal device 110. In some embodiments, the application 112 and the digital assistant 114 may also be accessed in other manners, for example, accessed through a web page. Although a single application 112 and a single digital assistant 114 are separately shown, the digital assistant 114 may be integrated into the application 112. Alternatively and/or additionally, the digital assistant 114 may be invoked by a plurality of applications.

In the embodiments of the present disclosure, the application 112 may be any appropriate application having a reply function, which may include but is not limited to one or more of the following: a chat application component (also referred to as an instant messaging application component), a browser application component, a planning application component, a document application component, an audio and video conference application component, an email application component, a task application component, a calendar application component, an objective and key results (OKR) application component, and the like. It may be understood that although a single application is shown in FIG. 1A, a plurality of applications may actually be installed on the terminal device 110. In some embodiments, the application 112 may include a multifunctional collaboration platform, for example, an office collaboration platform (also referred to as an office suite) may provide integration of a plurality of types of service components to facilitate activities such as office work and communication. In the multifunctional collaboration platform, people may start different service components as needed to complete corresponding information processing, sharing, communication, and the like.

In some embodiments, the digital assistant 114 may be provided by a separate application, or may be integrated into a certain application 112 that may provide a content entity. An application service component for providing a client interface of the digital assistant may correspond to a single-function application service component or a multifunctional collaboration platform, such as an office suite or other collaboration platforms that may integrate a plurality of components. It may be understood that, similar to the application, although a single digital assistant is shown in FIG. 1A, there may actually be a plurality of digital assistants.

In some embodiments, the digital assistant 114 supports the use of plugins. Each plugin may provide one or more functions of the application. Such plugins include but are not limited to one or more of the following: a search plugin, a contact plugin, a message plugin, a document plugin, a table plugin, an email plugin, a calendar plugin, a schedule plugin, a task plugin, and the like.

The digital assistant 114 is an intelligent assistant of the user, and has intelligent conversation and information processing capabilities. In the embodiments of the present disclosure, the digital assistant 114 is configured to interact with the user 140, to assist the user 140 in using the terminal device 110 or the application 112. In some embodiments, a plurality of interaction modes between the user 140 and the digital assistant 114 may be provided, and flexible switching between the plurality of interaction modes is possible. In the case where a certain interaction mode is triggered, a corresponding interaction region is presented to facilitate the interaction between the user 140 and the digital assistant 114. Interaction manners between the user 140 and the digital assistant 114 in different interaction modes are different, so that interaction requirements in different application scenarios may be flexibly adapted to. Alternatively and/or additionally, the digital assistant may be installed in the application in the form of a plugin, and invoked by the application.

In the environment 100A, in response to the application 112 being launched, the terminal device 110 may present an interface 150 of the application 112 and/or the digital assistant 114. The interface 150 may include, for example, an interaction interface of the application 112 and the digital assistant 114. In some embodiments, an interaction window between the user 140 and the digital assistant 114 may be presented in the interface 150. In the interaction window, the user 140 may chat with the digital assistant 114 by inputting a natural language, a picture, an audio file, a video file, a web page file, etc., to instruct the digital assistant to assist in completing various tasks.

The interaction window between the digital assistant 114 and the user 140 may include a chat window, for example, a chat window in an instant messaging application or an instant messaging module of a specific application. In the chat window, the interaction between the digital assistant 114 and the user 140 may be presented in the form of chat messages. Alternatively or additionally, the interaction window between the digital assistant 114 and the user 140 may further include another type of window, for example, a window in a floating window mode, in which the user 140 may trigger the digital assistant 114 to perform a corresponding operation by inputting an instruction, selecting a quick instruction, etc.

In some embodiments, the digital assistant 114 may support an interaction mode of the chat window, which is also referred to as a chat mode. In this interaction mode, the chat window between the user 140 and the digital assistant 114 is presented, and the user 140 and the digital assistant 114 interact through chat messages in the chat window. In the chat mode, the digital assistant 114 may perform a task based on the chat messages in the chat window. In the interaction window, the user 140 inputs an interaction message, and the digital assistant 114 provides a reply message in response to the user input. By selecting the digital assistant 114, the chat window with the digital assistant 114 may be opened. The chat window may include interface elements for information exchange, such as an input box, a message list, and message bubbles.

In some embodiments, a communication connection is established between the terminal device 110 and the server 120. The communication connection may be established in a wired or wireless manner. The communication connection may include but is not limited to a Bluetooth connection, a mobile network connection, a Universal Serial Bus (USB) connection, a Wireless Fidelity (WiFi) connection, etc., and the embodiments of the present disclosure are not limited in this regard. In the embodiments of the present disclosure, the terminal device 110 and the server 120 may implement signaling interaction through the communication connection therebetween, to implement provision of services of the application 112 and/or the digital assistant 114.

As shown in FIG. 1A, the server 120 may invoke a machine learning model 130 to support the reply function of the application 112 based on an output of the machine learning model 130. The machine learning model 130 may be based on any appropriate model structure, including but not limited to a Transformer model, a convolutional neural network (CNN), a recurrent neural network (RNN), a deep neural network (DNN), and the like. In some embodiments, the machine learning model 130 may be based on a language model (LM). The language model may have a question answering capability by learning from a large amount of corpus. The machine learning model 130 may also be based on other appropriate models.

The machine learning model 130 may be deployed on the server 120, or may be deployed on another device, for example, deployed at the terminal device 110. The machine learning model 130 may include one or more machine learning models. It should be noted that if the machine learning model 130 includes a plurality of machine learning models, the plurality of machine learning models may have the same or different structures, purposes, and functions, which are not limited in the present disclosure. It should be noted that a machine learning model (not shown in the figure) may also be deployed locally on the terminal device 110, and the terminal device 110 may also directly invoke the local machine learning model to support the reply function of the application 112 based on an output of the local machine learning model.

The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a game device, or any combination thereof, including fittings and peripherals of these devices, or any combination thereof. In some embodiments, the terminal device 110 may also support any type of user-specific interface (such as a "wearable" circuit, etc.).

The server 120 may be an independent physical server, or a server cluster or a distributed system composed of a plurality of physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server 120 may include, for example, a computing system/server, such as a mainframe, an edge computing node, a computing device in a cloud environment, and the like.

It should be understood that the structures and functions of the elements in the environment 100A are described for illustrative purposes only, and do not imply any limitation to the scope of the present disclosure.

As mentioned above, the user may complete diverse operations through various interactions with the digital assistant. The user may provide user input of at least one modality to the digital assistant, and the digital assistant may then determine a corresponding reply based on the received user input. Traditionally, in a multimodal interaction process between the user and the digital assistant, the user may send a query and media data pre-stored locally to the digital assistant. The digital assistant may then provide a reply to the query based on the media data. The user needs to obtain the media data first, and then provide the pre-obtained media data to the digital assistant, and the real-time performance of the media data is poor. In addition, the digital assistant cannot obtain the media data obtained by the client device of the user in real time, which may affect the efficiency of query and reply.

In view of this, according to the embodiments of the present disclosure, an improved solution for query is provided. More details are described with reference to FIG. 1B, which is a schematic diagram 100B of a query process according to some embodiments of the present disclosure. As shown in FIG. 1B, in the solution according to the embodiments of the present disclosure, first media data 154 is obtained by a first acquisition device 152 of a terminal device. Whether second media data 158 needs to be obtained may be determined based on the first media data 154 and a query 142. In response to determining, based on the first media data 154 and the query 142, that the second media data 158 needs to be obtained, the second media data 158 is obtained by a second acquisition device 156 of the terminal device. A reply 132 to the query 142 is provided based on the first media data 154 and the second media data 158.

Herein, the terminal device may include a plurality of acquisition devices, for example, the first acquisition device 152 may include an image acquisition device, a sound acquisition device, etc. for acquiring data from an external environment of the terminal device; and the second acquisition device 156 may include an image acquisition device, a sound acquisition device, a text acquisition device, etc. for acquiring data from an interior of the terminal device. In this way, in the multimodal query process, the media data and the query may be obtained in real time, which may not only support rich query manners, but also improve the input efficiency of the user. Further, the user may be supported to express his/her needs in a more accurate manner, and a more accurate reply may be provided based on a more accurate query need. In this way, different pieces of media data may be supported to be obtained via different acquisition devices, respectively, so that the user query may be supported in a more comprehensive manner.

In some embodiments, the first media data comes from an external environment of the terminal device, and the second media data comes from an application running on the terminal device. More details are described with reference to FIG. 1C, which is a schematic diagram 100C of media data acquisition according to some embodiments of the present disclosure. As shown in FIG. 1C, the terminal device 110 may be located in a physical environment 122, for example, a user may hold the terminal device 110 by hand and acquire video data, image data, sound data, etc. of the physical environment 122; alternatively and/or additionally, text data may be extracted from the acquired data, for example, text may be recognized from data such as a video, an image, and a sound, etc. At this time, the first media data 154 may have different modalities, such as a video, an image, a sound, a text, etc.

Alternatively and/or additionally, one or more applications, such as the application 112, etc., may run on the terminal device 110. The second media data 158 may be acquired from at least one application. Herein, the first media data and the second media data may have a same modality. Alternatively and/or additionally, the first media data and the second media data may have different modalities. In this way, multimodal data processing may be supported in richer manners. For example, the first media data may be a video of the physical environment 122 captured by a camera, and assuming that the query is "where is this place", it may be determined that there is no need to acquire the second media data. For another example, assuming that the query is "is this the museum in the travel notes I've just read", the second media data may be acquired from the application at this time. Specifically, relevant data such as a video, a text, and an image may be acquired from the travel application previously used by the user, and then whether the content in the first media data is consistent with the museum in the travel notes may be determined, and then a reply may be provided.

In some embodiments, the first media data may be continuously acquired, for example, the user may move within the physical environment 122 and shoot more videos of the physical environment 122 in real time. In this way, richer media data may be provided for the query, and the accuracy of the query may be improved.

In some embodiments, in the process of providing the reply to the query, a prompt for processing the query may be generated based on the first media data, the second media data, and the query; and then the reply is provided based on an answer to the prompt from the machine learning model. In the above example, the name "XXX" of the museum may be determined from the second media data. At this time, an example of the prompt may be expressed as: "please determine whether the building in the first media data is the XXX museum". Alternatively and/or additionally, an image (or video) of the museum, etc. may be extracted from the second media data. At this time, an example of the prompt may be expressed as: "please determine whether the building in the first media data is consistent with the museum in the image (or video)", etc. Alternatively and/or additionally, a description of the museum may be extracted from the second media data, for example, "a five-story building, a marble exterior wall, ...". At this time, an example of the prompt may be expressed as: "please determine whether the building in the first media data is consistent with the following description", etc.

It should be understood that although the query process is described above by using video data as an example of the first media data, alternatively and/or additionally, the first media data may include audio data. For example, the sound acquisition device in the terminal device may record a song played in the physical environment 122, and assuming that the query is "is this the singer introduced in the news", the name of the singer may be searched for from a news application in the terminal device, and further processing may be performed. For another example, assuming that the query is "have I downloaded this song", a song that has been downloaded may be searched for from a music application in the terminal device, and further processing may be performed.

In some embodiments, the method of the present disclosure is performed in a first application running in the terminal device, and obtaining, by the second acquisition device of the terminal device, the second media data includes: determining an application from at least one second application running on the client device; and acquiring the second media data from the application. Specifically, one or more applications may run on the terminal device, and at this time, the data source of the second media data 158 may be determined in various manners. For example, the method of the present disclosure may be performed in the digital assistant 114 (for example, also referred to as the first application), and the second media data may be acquired from the application 112 (for example, also referred to as the second application) different from the digital assistant 114.

More details are described with reference to FIG. 1D, which is a schematic diagram 100D of media data acquisition from an application running at a terminal device according to some embodiments of the present disclosure. As shown in FIG. 1D, a plurality of applications, such as applications 112, 116, 118, etc., may run on the terminal device 110. An application matching the first media data and the query may be selected from the plurality of applications based on various manners, and then the second media data may be acquired from the selected application.

In some embodiments, in the process of determining the application from the at least one second application running at the client device, at least one application identification of the at least one second application may be provided; and in response to receiving a selection request for an application identification from the at least one application identification, the application may be determined based on the selection request. For example, the application identification of the running application may be displayed at the terminal device 110. As shown in FIG. 1D, the plurality of application identifications may be displayed in different styles, for example, the plurality of applications may be displayed in a cascading manner, and the user may use a sliding operation to view the applications one by one, so as to select a desired application. Alternatively and/or additionally, the plurality of application identifications may be displayed in a tiled manner in a grid manner in a plurality of rows and columns, so that the user may select the desired application. For example, the first media data is a video of a physical environment, and the query is "is this the museum I've just seen"? Assuming that the user browsed museums in different applications (queried an introduction of museum A in a travel application, queried an address of museum B in a map application, etc.), at this time, identifications of the plurality of applications may be provided, so that the user may select a desired application. In this way, the user intention may be understood in a more accurate manner, thereby improving the accuracy of the query.

It should be understood that the second application herein may be an application that is launched at the terminal device (for example, being used in the foreground or running in the background), and alternatively and/or additionally, the second application may be an application installed at the terminal device. The application that has been used recently may be preferentially presented in a chronological order in which each application is used.

In some embodiments, in the process of determining the application from the at least one second application running at the client device, a machine learning model may be used to select a desired application from a plurality of second applications. Specifically, a prompt for determining the application may be generated based on the first media data and the query; and the application may be determined based on an answer to the prompt from the machine learning model. For example, an example of the prompt may include: please select an application matching the first media data and the query from the following plurality of applications, please select an application specified by the query, etc. In this way, the powerful processing capability of the machine learning model may be used to automatically determine the application that meets the user needs.

In some embodiments, in the process of determining the application from the at least one second application running at the client device, a correlation between at least one of the first media data or the query and the at least one second application may be determined; and the application may be determined from the at least one second application based on the correlation. Specifically, content information may be extracted from the first media data, and a correlation between each second application and the content information may be determined, respectively. For example, assuming that the content of the first media data is an image, the second media data may be preferentially acquired from an image application; and assuming that the content of the first media data is a song, the second media data may be preferentially acquired from a music application.

Alternatively and/or additionally, content information may be extracted from the query, and a correlation between each second application and the content information may be determined, respectively. For example, assuming that the query specifies "compare whether the first media data is consistent with the museum in the travel notes", the second media data may be preferentially acquired from the travel application, etc. Alternatively and/or additionally, based on both the first media data and the query, an application with a high correlation may be selected from the plurality of second applications. In this way, the user intention may be understood in a more accurate manner, thereby improving the accuracy of processing the query.

It should be understood that although the example of selecting one application from the plurality of second applications and acquiring the second media data from the selected application is described above, alternatively and/or additionally, a plurality of applications may be selected, and the second media data may be acquired from the plurality of applications, respectively. Assuming that the query is: "is this the museum I've searched for"? Assuming that the museum was previously queried in the map application and the travel application, respectively, the second media data may be acquired from each of the two applications.

The query process has been described, and some example embodiments of the present disclosure will be described below with continued reference to the drawings. The query method involved in the present disclosure may be implemented on the terminal device 110, and the processing capability of the server 120 may be invoked. For the convenience of description, the query method implemented on the terminal device 110 is taken as an example for description. It should be noted that the operations performed by the terminal device 110 may be specifically performed by a related application and/or the digital assistant installed on the terminal device 110. It should be noted that if the query method implemented on the server 120 is taken as an example for description, the server 120 needs to receive data from the terminal device 110 and send data to the terminal device 110 via the communication connection with the terminal device 110. Similarly, it may be understood that some operations described with reference to the terminal device 110 may need the assistance of the server 120 to be completed.

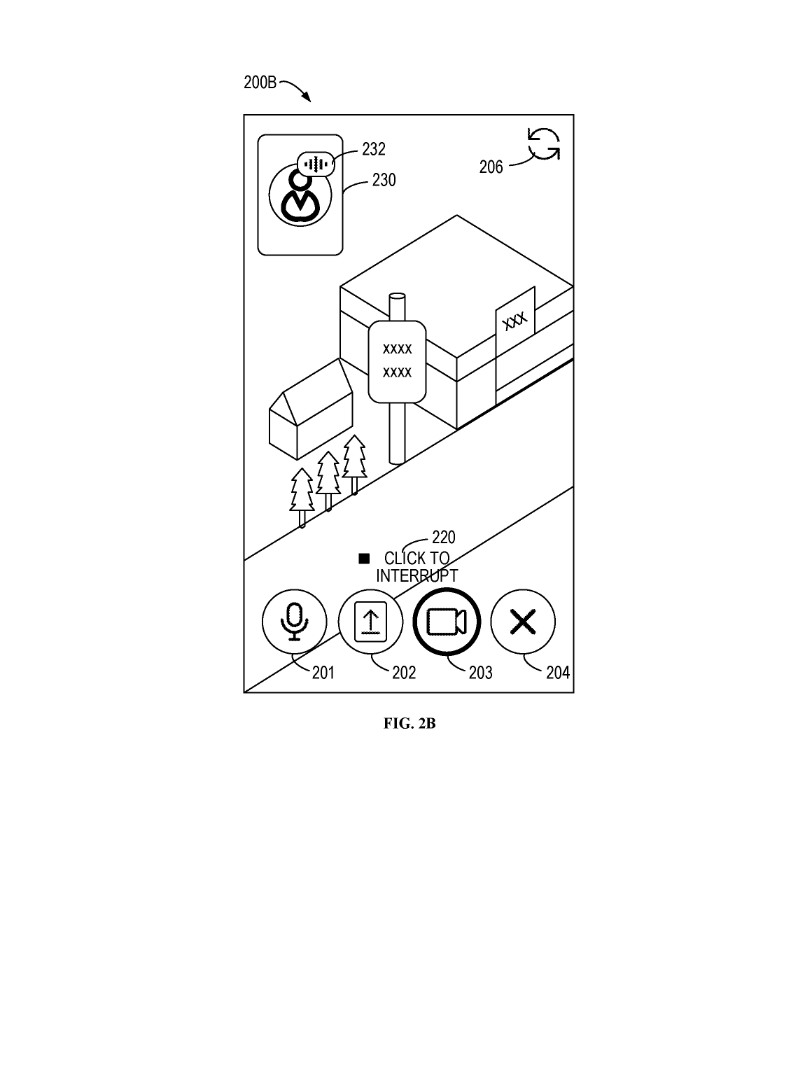

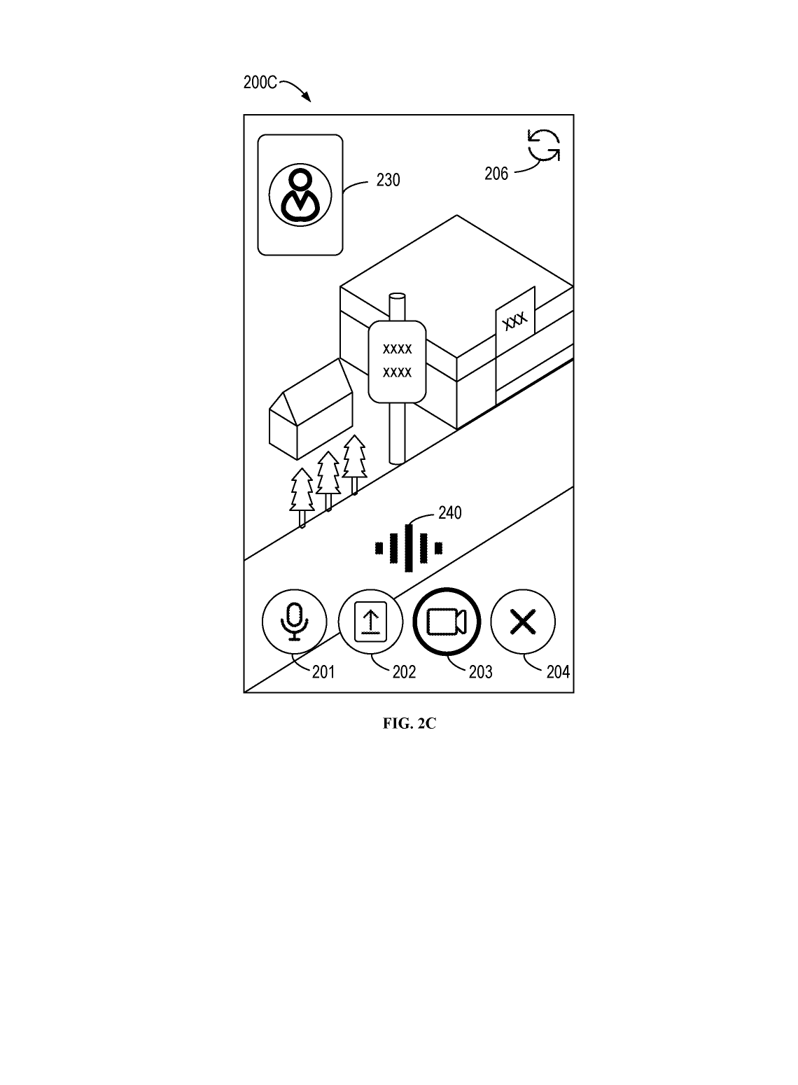

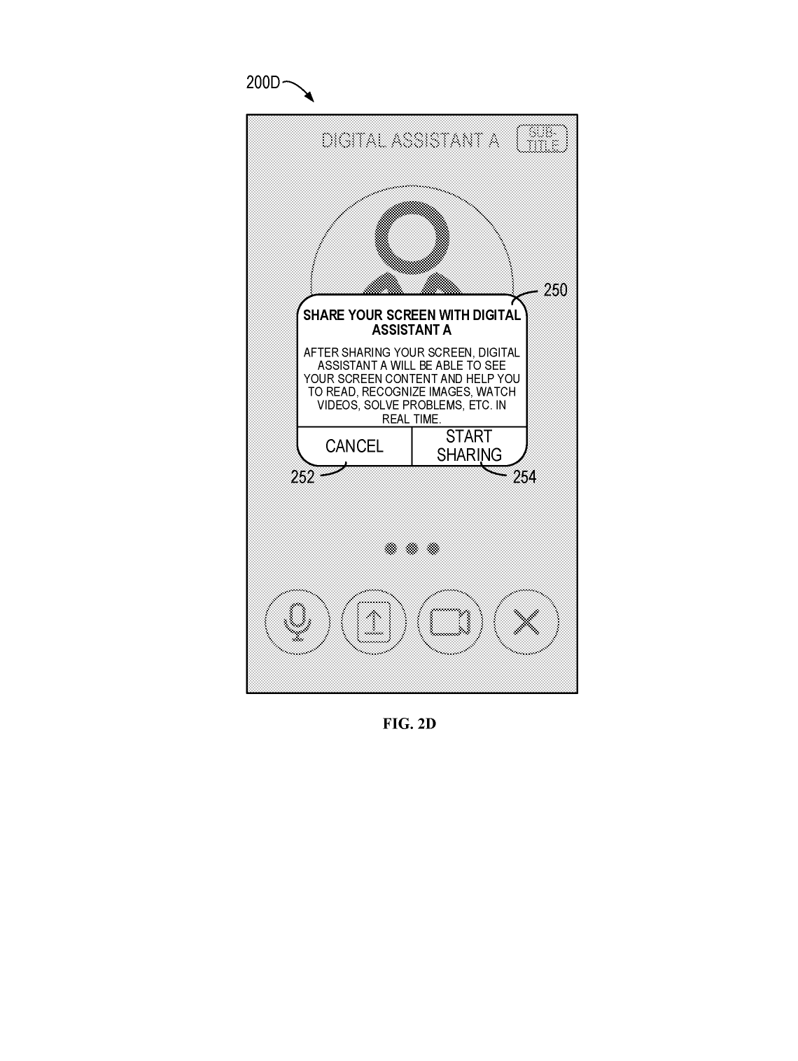

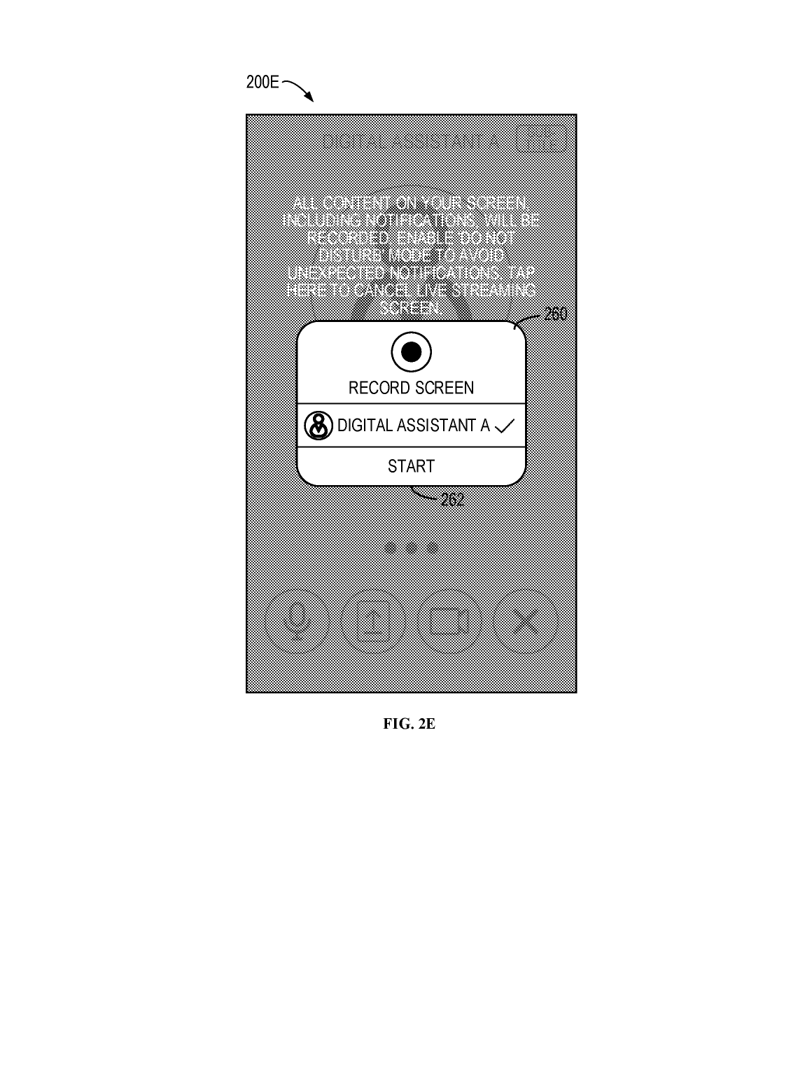

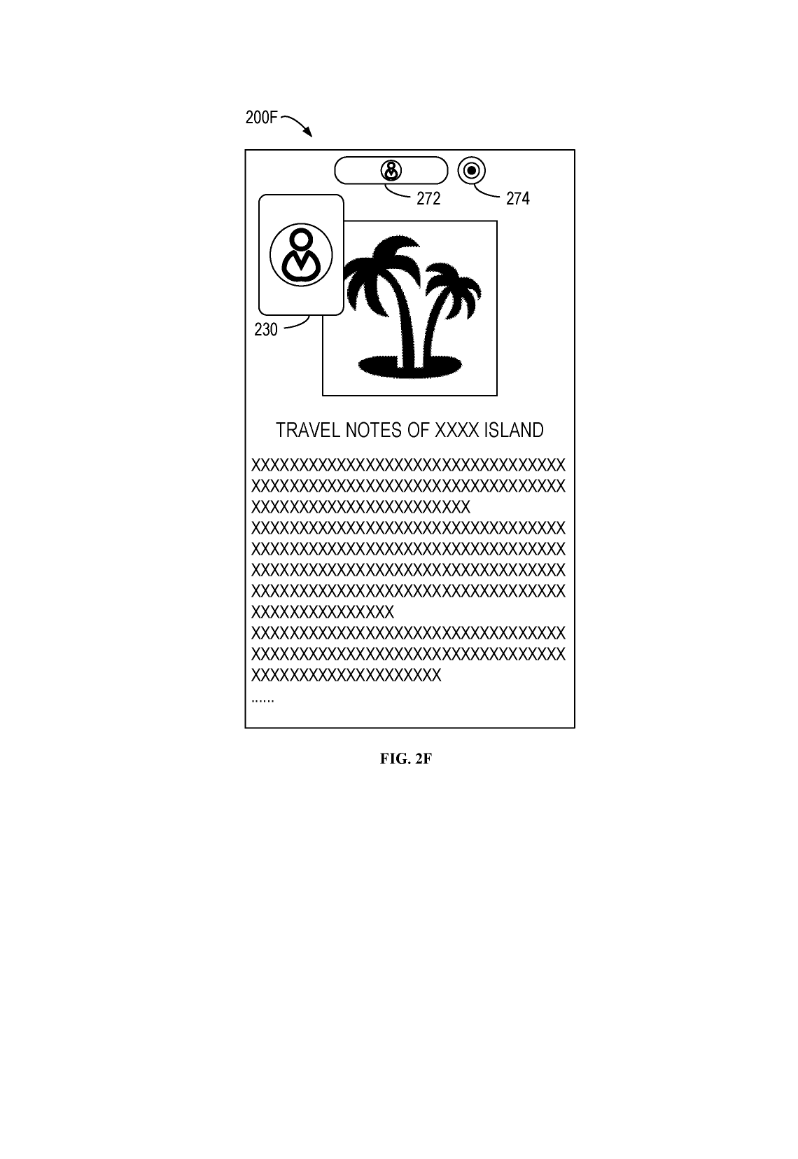

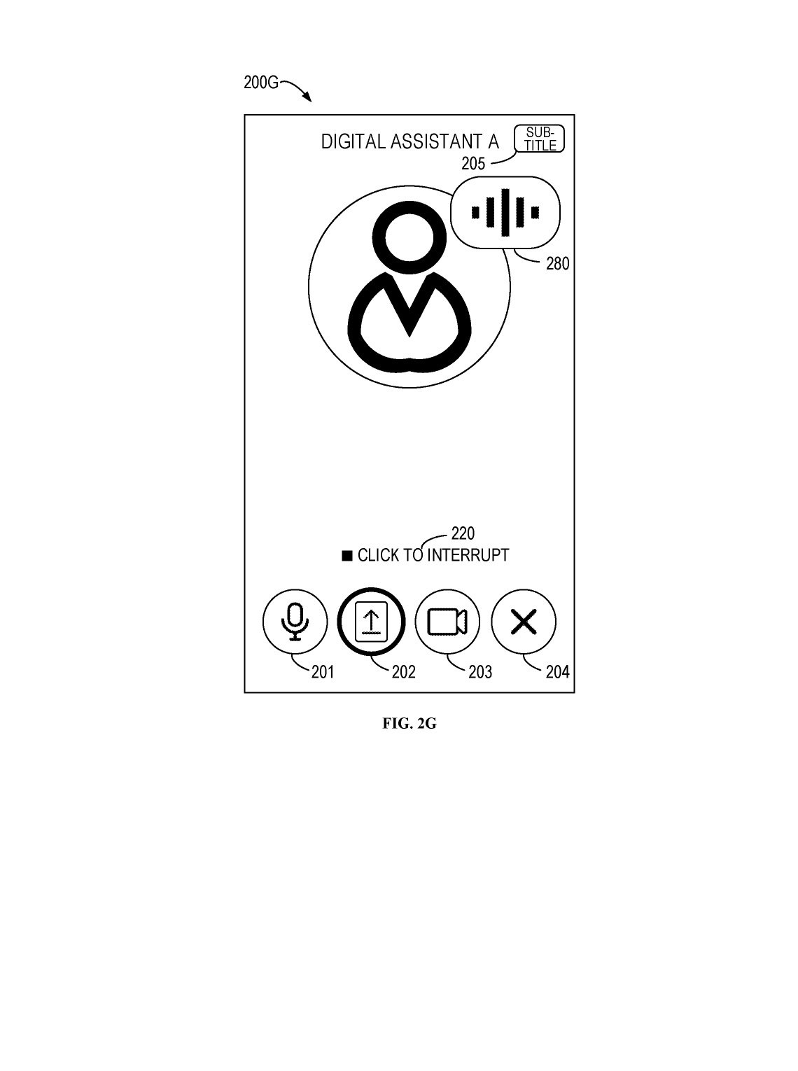

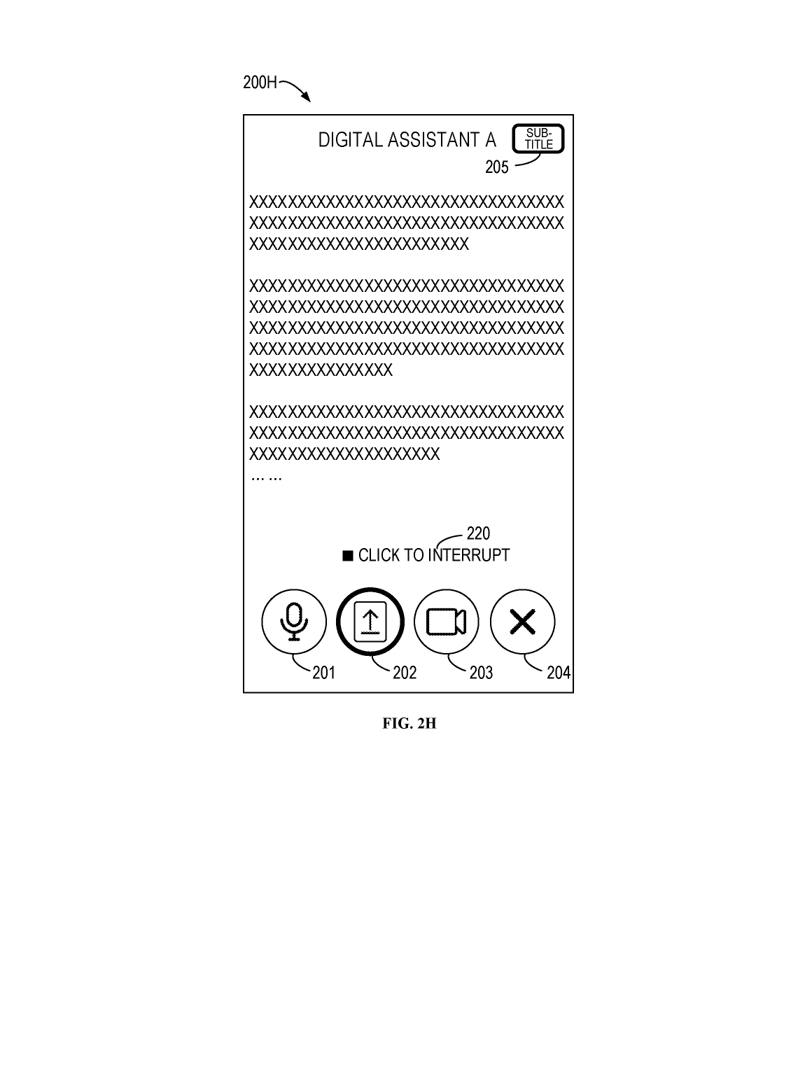

FIG. 2A to FIG. 2H show example interfaces 200A to 200H (which may also be referred to as examples 200A to 200H for short) according to some embodiments of the present disclosure. The interfaces shown in examples 200A to 200H may be presented at the terminal device 110. For the convenience of discussion, examples 200A to 200H will be described with reference to the environment 100A in FIG. 1A. It should be understood that the interfaces shown in the drawings are only examples, and various interface designs may actually exist. Each graphic element in the interface may have different arrangements and different visual representations, one or more elements therein may be omitted or replaced, and there may also be one or more other elements. The embodiments of the present disclosure are not limited in this regard.

A digital assistant (such as the digital assistant 114) may run on the terminal device 110. The method of the present disclosure may be performed by the terminal device 110. Specifically, in the digital assistant, media data corresponding to an access request is obtained in response to receiving the access request for a media control. The media data may include image data and/or video data. The terminal device 110 may further receive a query from the user.

For example, the terminal device 110 may provide an interaction interface between the user and the digital assistant during an interaction process between the user (such as the user 140) and the digital assistant. Referring to FIG. 2A, example 200A shows an example of the interaction interface. Example 200A presents an identification of the digital assistant currently interacting with the user, and the identification includes a name of the digital assistant (such as "digital assistant A" in the figure), an avatar of the digital assistant, etc. Example 200A may further present a plurality of media controls in the digital assistant. The plurality of media controls may include a cancel control 204. The terminal device 110 may end the interaction between the user and the digital assistant in response to receiving a trigger on the cancel control 204.

The plurality of media controls may further include a video acquisition control 203. For example, the terminal device 110 may determine that the access request for the video acquisition control 203 is received in response to receiving a trigger on the video acquisition control 203. The terminal device 110 may receive the media data from a video acquisition unit (such as a camera) of the terminal device 110 in response to receiving the access request for the video acquisition control 203. For example, the terminal device 110 may start the camera and switch to presenting the interaction interface shown in example 200B in response to receiving the access request for the video acquisition control 203 in example 200A.

The interaction interface shown in example 200B presents the media data that may be acquired by the terminal device 110 via the camera. When the media data is not received, the terminal device 110 may present the video acquisition control 203 in a first visual style, and in the process of receiving the media data via the camera, the terminal device 110 may present the video acquisition control 203 in a different second visual style. The present disclosure does not limit the specific visual style. As only an example, the terminal device 110 may present the video acquisition control 203 in a visual style with a conventional border in example 200A, and present the video acquisition control 203 in a visual style with a bold border in example 200B. Alternatively and/or additionally, the enabled camera may be represented in other highlighted manners. Therefore, the terminal device 110 may capture a video/image of the environment where the terminal device 110 is located via the camera, so that information that is difficult to describe in language may be obtained easily, which facilitates the improvement of the accuracy of the reply.

In some embodiments, in the case where a plurality of cameras is included, the interaction interface shown in example 200B may further include a lens switching control 206. The terminal device 110 may switch the camera currently in use in response to receiving a trigger on the lens switching control 206. As an example, if the terminal device 110 includes a front-facing camera and a rear-facing camera, and the rear-facing camera is currently in use (that is, the currently presented media data is the media data obtained by using the rear-facing camera), the terminal device 110 may switch to using the front-facing camera and present the media data obtained via the front-facing camera in response to receiving the trigger on the lens switching control 206.

Alternatively and/or additionally, the plurality of media controls in example 200A may include an audio control 201. For example, the terminal device 110 may determine that an interaction request for the audio control 201 is received in response to receiving a trigger on the audio control 201. The terminal device 110 may receive audio data via an audio acquisition unit (such as a microphone) of the terminal device in response to receiving the interaction request for the audio control 201. In some embodiments, during the interaction between the user and the digital assistant, the audio control 201 may be in the triggered state by default. That is, the terminal device 110 may remain in an audio receiving state during the interaction between the user and the digital assistant, and always receive the audio data via the microphone. In the case of being in the audio receiving state (that is, during the reception of the audio data), the terminal device 110 may exit the audio receiving state and no longer receive the audio data in response to receiving the trigger on the audio control 201. In some embodiments, the terminal device 110 may directly determine the audio data as the query. For example, the received audio data may be converted into text data to serve as the query.

In some embodiments, while receiving the audio data via the microphone, the terminal device 110 may further present an audio reception indication. The audio reception indication may inform the user that the terminal device 110 is currently receiving the audio data. As an example, referring to FIG. 2C, while receiving the audio data, the terminal device 110 may present an audio reception indication 240 in example 200C. The audio reception indication 240 may indicate that the audio data is currently being received.

Alternatively and/or additionally, the plurality of media controls in example 200A may further include a screen sharing control 202. For example, the terminal device 110 may determine that an access request for the screen sharing control 202 is received in response to receiving a trigger on the screen sharing control 202. In some embodiments, the terminal device 110 may present the interaction interface shown in example 200D in response to receiving the access request for the screen sharing control 202 in example 200A. Example 200D includes a confirmation window 250, and the confirmation window 250 is used to prompt the user to confirm whether to share the screen (for example, the prompt text shown in the figure: "share the screen with the digital assistant A...answer questions, etc. after the screen sharing"), and includes a cancel control 252 and a confirmation control 254. The terminal device 110 may return to presenting the interaction interface shown in example 200A in response to receiving a trigger on the cancel control 252, and at this time, the reception of the media data based on the screen display interface of the terminal device 110 is prohibited.

The terminal device 110 may determine to receive the media data based on the screen display interface of the terminal device 110 in response to receiving a trigger on the confirmation control 254. For example, the terminal device 110 may switch to presenting the interaction interface shown in example 200F in response to receiving the trigger on the confirmation control 254. For example, the terminal device 110 may further switch to presenting the interaction interface shown in example 200E in response to receiving the trigger on the confirmation control 254. Example 200E includes a permission acquisition window 260. The permission acquisition window 260 may include a prompt text for prompting the user to authorize the digital assistant (such as "record the screen"), prompt information of the current digital assistant (such as "digital assistant A" in the figure), and a confirmation control 262. The terminal device 110 may determine that the digital assistant A obtains the permission to record the screen in response to receiving a trigger on the confirmation control 262. The terminal device 110 may further switch to presenting the interaction interface shown in example 200F after the digital assistant A obtains the permission.

In some embodiments, the permission obtaining window 260 may further include a cancel control (not shown in the figure), and the terminal device 110 may determine that the digital assistant A does not obtain the permission to record the screen and cannot receive the media data based on the screen display interface of the terminal device 110 in response to receiving a trigger on the cancel control. For example, the terminal device 110 may return to presenting example 200A.

Although the media data acquisition from the application running in the foreground is described above, alternatively and/or additionally, the media data may be acquired from other applications running on the terminal device. For example, the media data may be automatically acquired from one or more applications running on the terminal device. Specifically, during the launch of the digital assistant, the confirmation window 250 may be automatically presented to allow the media data to be acquired from the one or more applications running on the terminal device. Further, a list of installed applications may be provided, and the user may select one or more applications from the list that allow the media data to be acquired; alternatively and/or additionally, the user may specify that the media data is only allowed to be acquired from the application running in the foreground, may specify that the media data is allowed to be acquired from the application running in the background, etc. In this way, while improving data security, the user may be supported to express his/her needs in a more accurate manner.

In some embodiments, the interaction interfaces shown in FIG. 2D and FIG. 2E may be skipped, and the screen may be directly shared with the digital assistant. Specifically, the terminal device 110 may receive the media data based on the screen display interface of the terminal device 110 in response to receiving the access request for the screen sharing control 202 in FIG. 2A. For example, the terminal device 110 may directly switch to presenting example 200F in response to receiving the access request for the screen sharing control 202 in example 200A. Example 200F shows an example of the screen display interface of the terminal device 110, and the content presented in the screen display interface shown in example 200F may be, for example, the content of another application other than the digital assistant. Switching the screen display interface from example 200A to example 200F may be referred to as switching from the interaction interface of the digital assistant to an interface of another application other than the digital assistant.

Example 200F may include a prompt text (such as the text shown in the figure: "the screen includes...cancel live screen recording"), and the prompt text may be used to prompt the user that the authorization for the digital assistant A may be cancelled by triggering other areas of the permission acquisition window 260 in example 200F. That is, the terminal device 110 may determine that the digital assistant A does not obtain the permission to record the screen and cannot receive the media data based on the screen display interface of the terminal device 110 in response to receiving a trigger on the other areas of the permission acquisition window 260 in example 200F.

In some embodiments, in the case where the screen display interface is an interface of another application other than the digital assistant (for example, in the case where example 200F is presented), the terminal device 110 may superimpose a screen sharing indication on the screen display interface, and the screen sharing indication may, for example, indicate that the screen display interface is shared with the digital assistant. Referring to FIG. 2F, example 200F may include a screen sharing indication 274, and the screen sharing indication 272 may inform the user that the interface is currently shared with the digital assistant. In some embodiments, the example 200F may further include an element 272, and an identification of the application currently active in the terminal device 110 may be presented on the element 272. As an example, since the screen display interface is currently shared with the digital assistant A, the digital assistant A is active, and the identification of the digital assistant A may be presented in the element 272. Therefore, the user may provide the media data to the digital assistant by sharing the screen with the digital assistant, which enriches the manners of providing the media data, improves the richness of information provided to the digital assistant, and facilitates the improvement of the accuracy of the reply. The user may know that the digital assistant is currently receiving the media data via the superimposed sharing indication, thereby avoiding providing wrong screen data to the digital assistant.

In some embodiments, while obtaining the media data, the terminal device 110 may present the media data being obtained on the screen display interface. In this case, the terminal device 110 may also superimpose a thumbnail representation of the digital assistant on the screen display interface. Referring to FIG. 2B, FIG. 2C, and FIG. 2F, example 200B, example 200C, and example 200F may further include a thumbnail representation 230. The thumbnail representation 230 may present an identification of the digital assistant (such as the avatar of the digital assistant A) being interacted with. On the one hand, the thumbnail representation 230 may inform the user that he/she is currently in the interaction process with the digital assistant, and the digital assistant is obtaining the media data. On the other hand, the terminal device 110 may also determine that an interaction request for the thumbnail representation 230 is received in response to receiving a trigger on the thumbnail representation 230.

The terminal device 110 may switch the screen display interface of the terminal device 110 to the digital assistant in response to receiving the interaction request for the thumbnail representation 230. That is, the terminal device 110 may switch back to presenting the interaction interface with the digital assistant in response to receiving the interaction request for the thumbnail representation 230. For example, the terminal device 110 may determine to stop receiving the media data via the screen display interface of the terminal device 110 (that is, the digital assistant A no longer has the sharing permission) in response to receiving the interaction request for the thumbnail representation 230 in example 200F. In this case, the terminal device 110 may switch back to presenting example 200A.

For example, the terminal device 110 may also return to presenting the interaction interface with the digital assistant in response to receiving the interaction request for the thumbnail representation 230, but maintain the screen sharing permission of the digital assistant A (that is, the digital assistant A may still receive the media data via the screen display interface). In this case, the terminal device 110 may switch back to presenting example 200G. After the terminal device 110 switches to presenting example 200G, the reception of the media data shown in example 200F may be paused, and the terminal device 110 may continue to obtain the media data in response to switching back to presenting the another application. At this time, the terminal device 110 no longer needs the confirmation of the user, that is, example 200D and example 200E no longer need to be presented.

It should be noted that, in some embodiments, the terminal device 110 may obtain the media data via the camera and the screen display interface, respectively. Alternatively and/or additionally, the terminal device 110 may also obtain the media data via the camera and the screen display interface in parallel. In this case, two channels of media data obtained in the two manners may be merged and provided to the digital assistant. For example, a video frame of a screen-recorded video may be provided in a gap between video frames of a video captured by the camera.

In some embodiments, the terminal device 110 may perform automatic speech recognition (ASR) on the received audio data to determine text data corresponding to the audio data. For example, the terminal device 110 may perform the speech recognition on the audio data using a trained ASR model to determine the text data. The ASR model may be a machine learning model local to the terminal device 110, or may be a machine learning model deployed in other devices (such as a remote device). The terminal device 110 may determine the query based on the text data corresponding to the audio data. For example, the terminal device 110 may directly determine the text data as the query. Therefore, the text may be determined based on the acquired audio data without manual input of the user, and the efficiency of obtaining the query may be improved.

In some embodiments, in the process of determining whether the second media data needs to be obtained, a correlation between the query and the first media data may be determined in response to determining that a difference between an acquisition time of the first media data and an acquisition time of the query satisfies a predetermined time range; and in response to determining that the correlation satisfies a predetermined threshold condition, it is determined that the second media data needs to be obtained. Specifically, the terminal device 110 may determine the correlation between the query and the media data in response to determining that the query is received within the predetermined time range. The predetermined time range may be any appropriate time range. As an example, the terminal device may determine that the query is received within the predetermined time range in response to a difference between a time when the reception of the query starts and a time when the media data is received being less than a predetermined duration. For example, the terminal device 110 may determine that the query is received within the predetermined time range in the case where the query is received while the media data is received (for example, the user speaks out the query while shooting a video), the query is received within 1 minute before the media data is received, the query is received within 1 minute after the media data is completely received, etc.

The terminal device 110 may determine a text description of the media data using the machine learning model, and then determine the correlation based on the query and the text description. The machine learning model may also be a machine learning model local to the terminal device 110, or may be a machine learning model deployed in other devices (such as a remote device). For example, the terminal device 110 may determine a text similarity between the text description and the query, and determine the text similarity as the correlation between the query and the media data. It may be understood that the more same or similar words the text description and the query include, the higher the text similarity between the two. In some embodiments, the terminal device 110 may also directly provide the media data and the query to the machine learning model, so as to directly determine the correlation therebetween with the aid of the machine learning model. For example, a value between 0 and 1 may be used to represent the correlation, and the present disclosure does not limit a specific method for determining the correlation.

The terminal device 110 may further obtain a predetermined threshold condition, and determine whether the correlation satisfies the predetermined threshold condition. The predetermined threshold condition may, for example, indicate a correlation threshold, for example, a correlation value is higher than a threshold of 0.7 (or other values). The terminal device 110 may determine that the correlation satisfies the predetermined threshold condition in response to the correlation reaching the correlation threshold. The terminal device 110 may determine that the correlation does not satisfy the predetermined threshold condition in response to the correlation not reaching the correlation threshold.

If it is determined that the correlation satisfies the predetermined threshold condition, the terminal device 110 may obtain the second media data, and provide the reply to the query based on the first media data and the second media data. For example, the terminal device 110 may use a trained reply model to determine the reply to the query based on at least the first and second media data and the query. The reply model may be a machine learning model local to the terminal device 110, or may be a machine learning model deployed in other devices (such as a remote device). As an example, if the media data is a video of a certain scenic spot, and the query is "is this the scenic spot in the travel notes, please provide the introduction information of the current scenic spot", at this time, the correlation between the query and the media data satisfies the predetermined condition, relevant media data of the scenic spot in the travel notes may be determined from the travel application, and then the reply may be provided. At this time, the reply may include, for example: this is the scenic spot in the travel notes, and the introduction information of the scenic spot is further provided. The terminal device 110 may provide the reply to the user in any appropriate manner. For example, the terminal device 110 may present the text corresponding to the reply via its own screen display interface, may play the audio corresponding to the reply via a speaker, etc.

If it is determined that the correlation does not satisfy the predetermined threshold condition, the terminal device 110 may obtain context data associated with the query based on an interaction history in the digital assistant. The interaction history is an interaction history between the user providing the query and the terminal device. The context data associated with the query may include historical interaction information between the user and the digital assistant, and the historical interaction information may include a historical query of the user, a historical reply to the historical query, historically obtained media data, and the like. In some embodiments, the context data associated with the query may further include any appropriate data such as system information of the terminal device 110, environment information of the physical environment in which the terminal device 110 is located, and user attribute information of the user who sends the query.

The terminal device 110 may provide the reply to the query based on the obtained context data associated with the query. For example, the terminal device 110 may use the trained reply model to determine the reply to the query based on the context data associated with the query and the query. Similarly, the reply model may be a machine learning model local to the terminal device 110, or may be a machine learning model deployed in other devices (such as a remote device). The terminal device 110 may provide the reply to the user. Determining the reply based on the context data may ensure the accuracy of the provided reply.

In some embodiments, the terminal device 110 may further provide feedback information to obtain another query for the media data. The feedback information may be used to prompt the user that the correlation between the query and the currently obtained media data is poor, and prompt the user to provide a query with a higher correlation with the media data. As an example, if the media data is a video of a certain scenic spot, and the query is "what date is today", the terminal device 110 may determine that the correlation between the media data and the query does not satisfy the predetermined threshold condition, obtain the context data associated with the query, and provide the reply based on the context data. The reply may be, for example, "today's date is XX year, XX month, and XX day". The terminal device 110 may further provide the feedback information "do you want to ask a question associated with the video". The terminal device 110 may provide the feedback information in any appropriate manner. For example, the terminal device 110 may present the text corresponding to the feedback information via its own screen display interface, may play the audio corresponding to the feedback information via a speaker, etc.

The terminal device 110 may receive the another query, and determine another correlation between the another query and the media data. The terminal device 110 may determine whether the another correlation satisfies the predetermined threshold condition. The terminal device 110 may provide another reply to the another query based on the media data in response to determining that the another correlation satisfies the predetermined threshold condition. The terminal device 110 may provide the reply to the another query first and then provide the feedback information to the user to obtain other queries for the media data in response to determining that the another correlation does not satisfy the predetermined threshold condition. That is, the terminal device 110 may provide the reply to the query first and then obtain other queries in response to the query being uncorrelated with the media data, and may repeatedly determine the correlation between the newly obtained query and the media data.

In some embodiments, while providing the reply, the terminal device 110 may superimpose and present a reply provision indication on the screen display interface. The reply provision indication may be used to inform the user that the reply is currently provided to the user. For example, if the terminal device 110 only obtains the query but does not obtain the media data, the terminal device 110 may present the interaction interface shown in example 200A. If the terminal device 110 provides the reply via a speaker (that is, plays reply speech), example 200A may further present a reply provision indication 210 in the process of providing the reply, and the reply provision indication 210 is used to indicate that the reply speech is currently played.

For another example, if the terminal device 110 obtains the media data via the camera, the terminal device 110 may present the interaction interface shown in example 200B. If the terminal device 110 provides the reply via the speaker (that is, plays the reply speech), the terminal device 110 may superimpose and present the reply provision indication 232 on the thumbnail representation 230 of the digital assistant in the process of providing the reply, and the reply provision indication 232 is used to indicate that the reply speech is currently played.

For another example, if the terminal device 110 obtains the media data via the screen display interface, the terminal device 110 may switch back to presenting example 200G in response to the interaction request for the thumbnail representation. After that, if the terminal device 110 provides the reply via the speaker (that is, plays the reply speech), the terminal device 110 may superimpose and present the reply provision indication 280 at the identification of the digital assistant A (such as the avatar of the digital assistant A) in example 200G in the process of providing the reply, and the reply provision indication 280 is used to indicate that the reply speech is currently played.

In some embodiments, the interaction interface between the user and the digital assistant may further include a subtitle control. For example, example 200A and example 200G may include a subtitle control 205. The terminal device 110 may switch to presenting example 200H shown in FIG. 2H in response to receiving a trigger on the subtitle control 205. Example 200H may present the text corresponding to the reply. For example, the terminal device 110 may present the text in example 200H in a streaming manner, that is, as more replies are provided, the number of texts presented in example 200H also increases.

In some embodiments, the terminal device 110 may further present an interruption control in the screen display interface while providing the reply. For example, the terminal device 110 may further provide an interruption control 220 in example 200B, example 200G, and example 200H. The terminal device 110 may stop providing the reply to the user in response to receiving a trigger on the interruption control 220. Even if only a part of the reply is provided, the terminal device 110 will no longer provide the remaining part of the reply to the user. Therefore, if the reply currently provided does not meet the expectation of the user or the user is not interested in it, the user may instruct the terminal device 110 to stop providing the reply by triggering the interruption control 220, and the user may re-provide the query and/or instruct the terminal device 110 to recapture the media data, which facilitates the improvement of the efficiency of the reply.

In some embodiments, it is assumed that the second media data is acquired from a certain second application (for example, a travel application), a thumbnail representation of the second application may be superimposed and displayed on the terminal device, that is, the thumbnail representation of the application as the data source of the second media data may be superimposed and displayed. In this way, the user may be supported to know that the media data is currently acquired from the second application. In response to receiving an interaction for the thumbnail representation, a control for stopping the media data acquisition may be further provided, thereby improving the data security. Alternatively and/or additionally, a control for switching to the second application may be further provided, thereby quickly switching to the second application. It should be understood that the second media data acquired herein may include: data on a page currently presented by the second application, data on a page previously accessed in the second application, and the like. In this way, with the permission of the user, the needs of the user may be described in a more accurate manner.

In some embodiments, the terminal device 110 may further obtain the context data associated with the media data based on the interaction history in the digital assistant in response to determining that the query is not received within the predetermined time range. The context data associated with the media data may include historical interaction information between the user and the digital assistant, and the historical interaction information may include a historical query of the user, a historical reply to the historical query, historically obtained media data, and the like. In some embodiments, the context data associated with the media data may further include any appropriate data such as system information of the terminal device 110, environment information of the physical environment in which the terminal device 110 is located, and user attribute information of the user who sends the query.

The terminal device 110 may determine a query intention based on the context data associated with the media data and the query, and provide the reply to the media data based on the query intention. As an example, if the media data is a video of a certain scenic spot and the previous query of the user is "coffee recommendation", the terminal device 110 may determine that the query intention is to search for a coffee shop near the scenic spot corresponding to the media data. In this case, the terminal device 110 may also provide the feedback information to obtain the query for the media data. For example, the terminal device 110 may provide the feedback information "do you want to search for a coffee shop near scenic spot XX", "what do you want to ask about the video", etc.

In some embodiments, in response to determining that the difference between the acquisition time of the first media data and the acquisition time of the query does not satisfy the predetermined time range, the context data associated with the query is obtained based on the interaction history. The interaction history is an interaction history between the user providing the query and the terminal device. Further, a query intention may be determined based on the context data and the query; and the reply to the query may be provided based on the query intention. Specifically, if the interval between the first media data and the query is too long, for example, more than 3 minutes or other time intervals, it indicates that the query may be not related to the first media data. At this time, the context data related to the query may be obtained, for example, other questions the user asked the digital assistant, an interaction for the reply provided by the digital assistant, an interaction with other applications, etc. within a certain period of time before and after the query is received. At this time, the context data may reflect the latest query intention of the user, and therefore, the reply that better matches the expectation of the user may be provided based on the latest query intention.

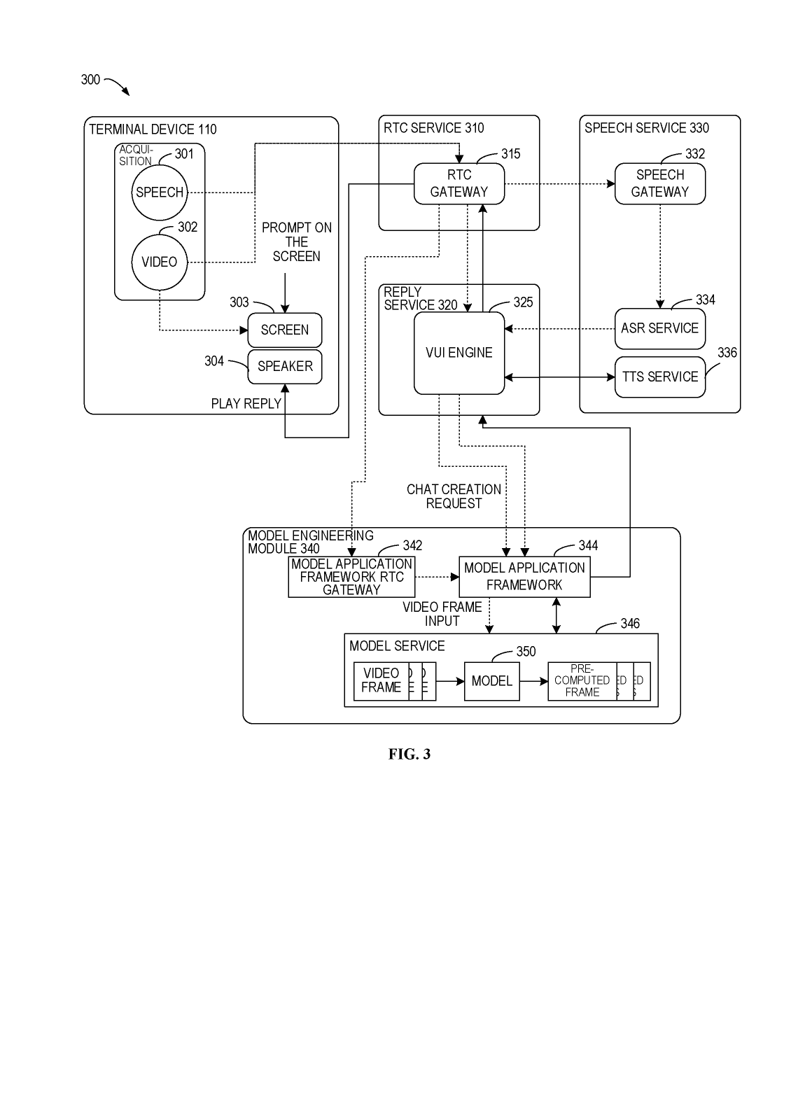

FIG. 3 shows an example 300 according to some embodiments of the present disclosure. A dotted arrow in example 300 indicates the transmission of uplink data, and a solid arrow indicates the transmission of downlink data. As shown in FIG. 3, the terminal device 110 may obtain a query (such as speech 301) and media data (such as video 302) in the process of interaction between the user 140 and the digital assistant. The terminal device 110 may present the acquired video 302 via a screen 303. The terminal device 110 may provide the acquired speech 301 and video 302 to an RTC gateway 315 of a real-time communication (RTC) service 310.

In some embodiments, the RTC gateway 315 may provide the acquired video 302 to a model engineering module 340 during the acquisition of the video 302. The model engineering module 340 may perform calculations on text, pre-computed frames, context data, and the like. For example, the model engineering module 340 may process video frames to obtain pre-computed frames, and may determine a reply based on the text and the pre-computed frames. The model engineering module 340 involves a model application framework RTC gateway 342, a model application framework 344, and a model service 346. The model application framework RTC gateway 342 is configured to receive the speech 301 and the video 302 sent by the RTC gateway 315. The model engineering module 340 acquires a plurality of video frames in the video 302, and may invoke a machine learning model (such as a vision-language model) to perform pre-encoding on the plurality of video frames to obtain a plurality of pre-computed frames.

After the acquisition of the video 302 and the speech 301 ends, the RTC gateway 315 may provide the speech 301 to a speech gateway 332 of a speech service 330. The speech gateway 332 may provide the speech 301 to an ASR service 334. The ASR service 334 may perform ASR processing on the speech 301 to determine the text corresponding to the speech 301. For example, the ASR service 334 may determine the text corresponding to the speech 301 with the aid of a trained ASR model. The ASR service 334 may provide the determined text to a speech interaction interface (VUI) engine 325 in a reply service 320.

The VUI engine 325 may provide the text and a session creation request corresponding to the interaction process to the model engineering module 340. The model engineering module 340 may invoke the machine learning model to determine a reply to the text based on the text and the pre-computed frames, and provide the reply to the VUI engine 325. The model engineering module 340 may directly use the plurality of pre-computed frames determined in the video acquisition process to determine a model output for the text. In this case, the model engineering module 340 does not need to encode the video frames again, and may directly invoke the pre-encoded result, which may improve the efficiency of model calculation, thereby improving the efficiency of the reply. Alternatively and/or additionally, one or more videos may be cached at the model service 346 (or at other locations accessible by the model 350). In the process of determining a query context, a video best matching the query may be determined from the one or more cached videos for use as the query context.

For example, the reply determined by the model engineering module 340 may be reply text, and the VUI engine 325 may provide the reply text to a text-to-speech (TTS) service 336 in the speech service 330. The TTS service 336 may perform TTS on the reply text to determine reply speech corresponding to the reply text. For example, the TTS service 336 may determine the reply speech with the aid of a trained TTS model. The VUI engine 325 may provide the reply speech to the terminal device 110 via the RTC gateway 315. The terminal device 110 may play the reply speech via a speaker 304.

In an example, the prompt may be determined based on at least one of the query, the media data, and an intermediate processing result for the query and the media data. The prompt may be input to the model 350, and the reply from the model may be received. For example, it is assumed that the media data is a video of a certain scenic spot that is shot, and the query is "where is this place"? The prompt may include, for example: "please determine the name and relevant introduction of the scenic spot in the video", etc. For another example, it is assumed that the media data is a shared page including travel notes, and the prompt may include, for example: "please provide a travel guide for the scenic spot in the video", etc.

To sum up, according to the embodiments of the present disclosure, in the multimodal query process, the media data and the query may be obtained in real time, and the reply to the query may be determined based on the media data in response to a strong correlation between the query and the media data. This may not only enrich the manners of query, but also help to improve the efficiency and quality of the reply.

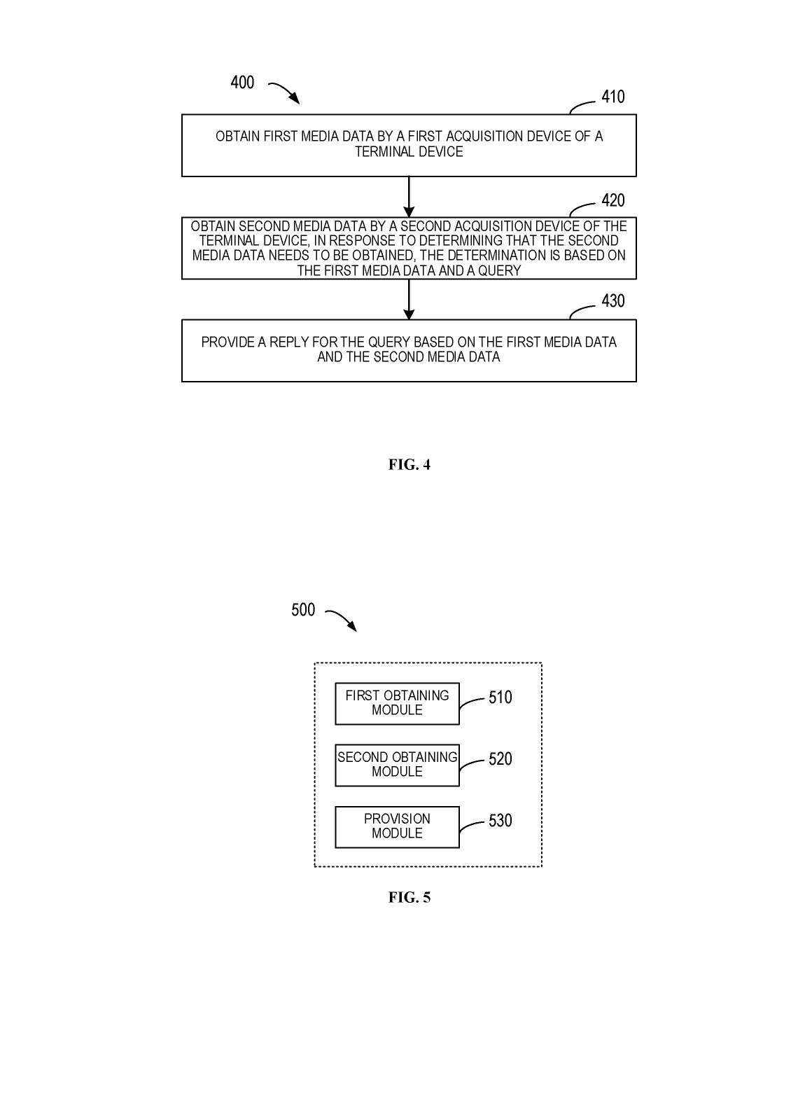

FIG. 4 is a flowchart of a method 400 for query according to some embodiments of the present disclosure. The method 400 may be implemented at the terminal device 110 in FIG. 1A. The method 400 will be described with reference to the environment 100A in FIG. 1A.

At block 410, first media data is obtained by a first acquisition device of a terminal device. At block 420, second media data is obtained by a second acquisition device of the terminal device, in response to determining that the second media data needs to be obtained, the determination is based on the first media data and a query. At block 430, a reply for the query is provided based on the first media data and the second media data.

In some embodiments, providing the reply for the query includes: generating a prompt for processing the query based on the first media data, the second media data, and the query; and providing the reply based on an answer for the prompt from a machine learning model.

In some embodiments, the first media data comes from an external environment of the terminal device, and the second media data comes from an application running in the terminal device.

In some embodiments, the method 400 is performed in a first application running in the terminal device, and obtaining the second media data by the second acquisition device of the terminal device includes: determining the application from at least one second application running at the client device; and acquiring the second media data from the application.

In some embodiments, determining the application from the at least one second application running at the client device includes: providing at least one application identification of the at least one second application; and determining the application in response to receiving a selection request for an application identification from the at least one application identification and based on the selection request.

In some embodiments, determining the application from the at least one second application running at the client device includes: generating a prompt for determining the application based on the first media data and the query; and determining the application based on an answer for the prompt from the machine learning model.

In some embodiments, determining the application from the at least one second application running at the client device includes: determining a correlation between at least one of the first media data or the query and the at least one second application; and determining the application from the at least one second application based on the correlation.

In some embodiments, the method 400 further includes: superimposing, in response to determining that a screen display interface of the terminal device is switched to the second application, a screen sharing representation on the screen display interface, the screen sharing representation indicating that the screen display interface is shared with the first application; and superimposing a thumbnail representation of the first application on the screen display interface.

In some embodiments, the method 400 further includes: switching the screen display interface of the terminal device to the first application in response to receiving an interaction request for the thumbnail representation.

In some embodiments, determining that the second media data needs to be obtained further includes: determining a correlation between the query and the first media data in response to determining that a difference between an obtaining time of the first media data and an obtaining time of the query satisfies a predetermined time range; and determining that the second media data needs to be obtained in response to determining that the correlation satisfies a predetermined threshold condition.

In some embodiments, the method 400 further includes: in response to determining that the correlation does not satisfy the predetermined threshold condition, obtaining context data associated with the query based on an interaction history, the interaction history being an interaction history between a user providing the query and the terminal device; and providing a reply for the query based on the context data.

In some embodiments, the method 400 further includes: obtaining context data associated with the query in response to determining that a difference between an obtaining time of the first media data and an obtaining time of the query does not satisfy a predetermined time range and based on an interaction history, the interaction history being an interaction history between a user providing the query and the terminal device; determining a query intention based on the context data and the query; and providing a reply for the query based on the query intention.

The embodiments of the present disclosure further provide a corresponding apparatus for implementing the above method or process. FIG. 5 is an example structural block diagram of an apparatus 500 for query according to some embodiments of the present disclosure. The apparatus 500 may be implemented as or included in the terminal device 110. Each module/component in the apparatus 500 may be implemented by hardware, software, firmware, or any combination thereof.

As shown in FIG. 5, the apparatus 500 includes: a first obtaining module 510 configured to o obtain first media data by a first acquisition device of a terminal device; a second obtaining module 520 configured to obtain second media data by a second acquisition device of the terminal device, in response to determining that the second media data needs to be obtained, the determination is based on the first media data and a query; and a provision module 530 configured to provide a reply for the query based on the first media data and the second media data.

In some embodiments, the provision module 530 is further configured to generate a prompt for processing the query based on the first media data, the second media data, and the query; and provide the reply based on an answer for the prompt from a machine learning model.

In some embodiments, the first media data comes from an external environment of the terminal device, and the second media data comes from an application running in the terminal device.

In some embodiments, the apparatus 500 is performed in a first application running on the terminal device, and the second acquisition module is further configured to include: determining the application from at least one second application running at the client device; and acquiring the second media data from the application.

In some embodiments, the second obtaining module 520 is further configured to provide at least one application identification of the at least one second application; and determine the application in response to receiving a selection request for an application identification from the at least one application identification and based on the selection request.

In some embodiments, the second obtaining module 520 is further configured to generate a prompt for determining the application based on the first media data and the query; and determine the application based on an answer for the prompt from the machine learning model.

In some embodiments, the second obtaining module 520 is further configured to determine a correlation between at least one of the first media data or the query and the at least one second application; and determine the application from the at least one second application based on the correlation.

In some embodiments, the provision module 530 is further configured to superimpose, in response to determining that a screen display interface of the terminal device is switched to the second application, a screen sharing representation on the screen display interface, the screen sharing representation indicating that the screen display interface is shared with the first application; and superimpose a thumbnail representation of the first application on the screen display interface.

In some embodiments, the provision module 530 is further configured to switch the screen display interface of the terminal device to the first application in response to receiving an interaction request for the thumbnail representation.

In some embodiments, the first obtaining module 510 is further configured to determine a correlation between the query and the first media data in response to determining that a difference between an obtaining time of the first media data and an obtaining time of the query satisfies a predetermined time range; and determine that the second media data needs to be obtained in response to determining that the correlation satisfies a predetermined threshold condition.

In some embodiments, the provision module 530 is further configured to: in response to determining that the correlation does not satisfy the predetermined threshold condition, obtain context data associated with the query based on an interaction history, the interaction history being an interaction history between a user providing the query and the terminal device; and provide a reply for the query based on the context data.

In some embodiments, the provision module 530 is further configured to obtain context data associated with the query in response to determining that a difference between an obtaining time of the first media data and an obtaining time of the query does not satisfy a predetermined time range and based on an interaction history, the interaction history being an interaction history between a user providing the query and the terminal device; determine a query intention based on the context data and the query; and provide a reply for the query based on the query intention.

In some embodiments, the first obtaining module 510 is further configured to determine a text description of the first media data by using a machine learning model; and determine the correlation based on the query and the text description.

The units and/or modules included in the apparatus 500 may be implemented in various ways, including software, hardware, firmware, or any combination thereof. In some embodiments, one or more units and/or modules may be implemented using software and/or firmware, such as machine-executable instructions stored on a storage medium. In addition to machine-executable instructions or as an alternative, some or all units and/or modules in the apparatus 500 may be implemented at least partially by one or more hardware logic components. As an example, rather than a limitation, example types of hardware logic components that may be used include field programmable gate array (FPGA), application specific integrated circuit (ASIC), application specific standard (ASSP), system on chip (SOC), complex programmable logic device (CPLD), and the like.

It should be understood that one or more steps of the above method may be executed by a suitable electronic device or a combination of electronic devices. Such an electronic device or a combination of electronic devices may include, for example, the terminal device 110 and/or the server 120 in FIG. 1A.

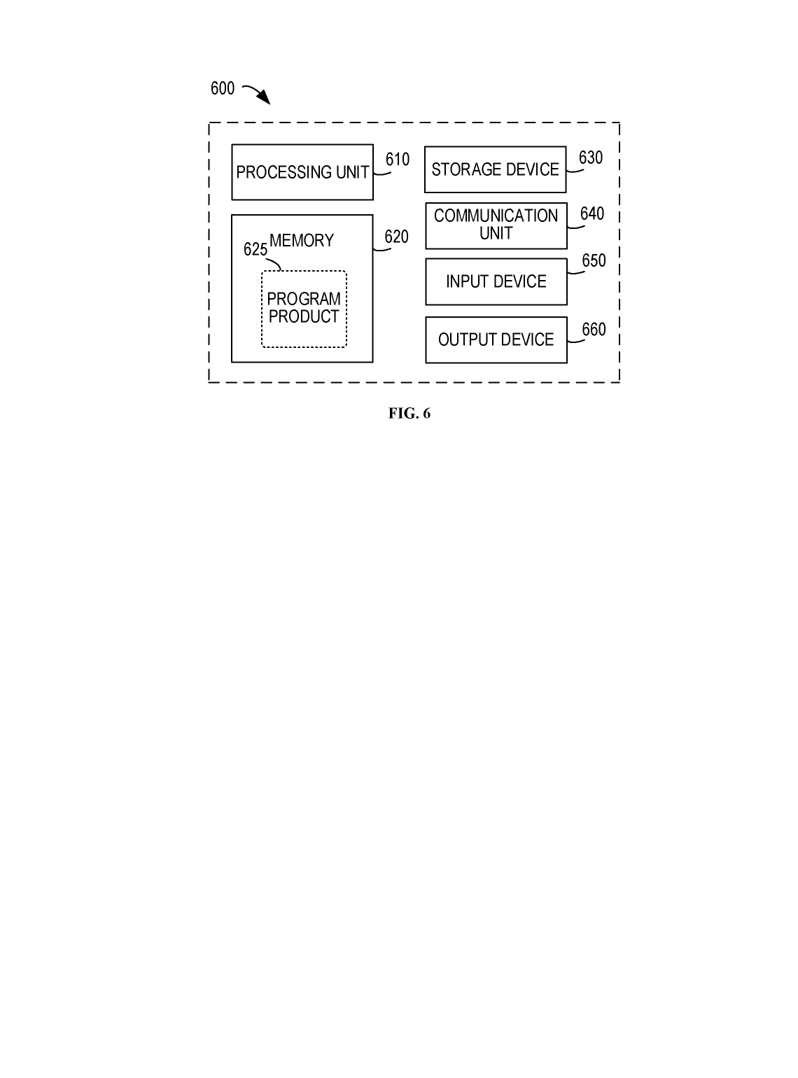

FIG. 6 is a block diagram of an electronic device 600 in which one or more embodiments of the present disclosure may be implemented. It should be understood that the electronic device 600 shown in FIG. 6 is only illustrative, and should not constitute any limitation on the functions and the scope of the embodiments described herein. The electronic device 600 shown in FIG. 6 may be used to implement the terminal device 110 and/or the server 120 in FIG. 1A.

As shown in FIG. 6, the electronic device 600 is in the form of a general electronic device. Components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor, and may execute various processes based on programs stored in the memory 620. In a multi-processor system, a plurality of processing units executes computer-executable instructions in parallel to improve the parallel processing capability of the electronic device 600.

The electronic device 600 typically includes a plurality of computer storage medium. Such medium may be any available medium accessible by the electronic device 600, including but not limited to volatile and non-volatile medium, removable and non-removable medium. The memory 620 may be a volatile memory (for example, a register, cache, a random access memory (RAM)), a non-volatile memory (such as a read-only memory (ROM), an electrically erasable programmable read-only memory (EEPROM), a flash memory), or any combination thereof. The storage device 630 may be any removable or non-removable medium, and may include a machine-readable medium such as a flash drive, a disk, or any other medium, which may be used to store information and/or data and may be accessed within the electronic device 600.

The electronic device 600 may further include other removable/non-removable, volatile/non-volatile memory medium. Although not shown in FIG. 6, a disk driver for reading from or writing to a removable, non-volatile disk (such as a "floppy disk"), and an optical disk driver for reading from or writing to a removable, non-volatile optical disk may be provided. In these cases, each driver may be connected to the bus (not shown) by one or more data medium interfaces. The memory 620 may include a computer program product 625, which has one or more program modules configured to perform various methods or acts of the various embodiments of the present disclosure.

The communication unit 640 implements communication with other electronic devices through a communication medium. Additionally, the functions of the components of the electronic device 600 may be implemented by a single computing cluster or a plurality of computing machines, which may communicate through communication connections. Therefore, the electronic device 600 may use a logical connection with one or more other servers, a network personal computer (PC) or another network node to operate in a networked environment.

The input device 650 may be one or more input devices, such as a mouse, a keyboard, a tracking ball, etc. The output device 660 may be one or more output devices, such as a display, a speaker, a printer, etc. The electronic device 600 may further communicate with one or more external devices (not shown) as needed through the communication unit 640, the external devices such as a storage device, a display device, etc., communicate with one or more devices that enable a user to interact with the electronic device 600, or communicate with any devices (such as a network card, a modem, etc.) that enable the electronic device 600 to communicate with one or more other electronic devices. Such communication may be performed via input/output (I/O) interfaces (not shown).

According to an example implementation of the present disclosure, there is provided a computer-readable storage medium having computer-executable instructions stored thereon, where the computer-executable instructions are executed by a processor to implement the method described above. According to an example implementation of the present disclosure, there is further provided a computer program product, the computer program product is tangibly stored on a non-transitory computer-readable medium and includes computer-executable instructions, and the computer-executable instructions are executed by a processor to implement the method described above.

Various aspects of the present disclosure are described herein with reference to the flowcharts and/or block diagrams of the method, the apparatus, the device, and the computer program product implemented according to the present disclosure. It should be understood that each block of the flowcharts and/or block diagrams, and combinations of blocks in the flowcharts and/or block diagrams may be implemented by computer-readable program instructions.

These computer-readable program instructions may be provided to a processing unit of a general-purpose computer, a special-purpose computer, or other programmable data processing apparatus to produce a machine, such that the instructions, when executed by the processing unit of the computer or other programmable data processing apparatus, produce an apparatus for implementing functions/actions specified in one or more blocks of the flowcharts and/or block diagrams. These computer-readable program instructions may also be stored in a computer-readable storage medium, the instructions cause a computer, a programmable data processing apparatus, and/or other devices to work in a specific manner, and thus, the computer-readable medium having the instructions stored therein includes a manufactured product, which includes instructions for implementing various aspects of the functions/actions specified in one or more blocks of the flowcharts and/or block diagrams.

The computer-readable program instructions may be loaded onto a computer, another programmable data processing apparatus, or another device, such that a series of operations and steps are performed on the computer, the other programmable data processing apparatus, or the other device to produce a computer-implemented process, so that the instructions executed on the computer, the other programmable data processing apparatus, or the other device implement the functions/actions specified in one or more blocks of the flowcharts and/or block diagrams.

The flowcharts and block diagrams in the drawings show the possibly implemented architectures, functions, and operations of the system, the method, and the computer program product according to a plurality of implementations of the present disclosure. In this regard, each block in the flowchart or block diagram may represent a module, program segment, or part of instructions, which includes one or more executable instructions for implementing the specified logical functions. In some updated implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and combinations of the blocks in the block diagrams and/or flowcharts may be implemented by a special-purpose hardware-based system that perform specified functions or actions, or may be implemented by a combination of special-purpose hardware and computer instructions.

The implementations of the present disclosure have been described above, and the above description is illustrative, non-exhaustive, and is not limited to the disclosed implementations. Many modifications and variations will be apparent to those of ordinary skill in the art without departing from the scope and spirit of the described implementations. The choice of terms used herein is intended to best explain the principles of the implementations, practical applications, or improvements to the technologies in the market, or to enable other those of ordinary skill in the art to understand the implementations disclosed herein.

1. A method for query, comprising:
obtaining first media data by a first acquisition device of a terminal device;
obtaining second media data by a second acquisition device of the terminal device, in response to determining that the second media data needs to be obtained, the determination being based on the first media data and a query; and
providing a reply for the query based on the first media data and the second media data.

2. The method of claim 1, wherein providing the reply for the query comprises:
generating a prompt for processing the query based on the first media data, the second media data, and the query; and
providing the reply based on an answer for the prompt from a machine learning model.

3. The method of claim 1, wherein the first media data comes from an external environment of the terminal device, and the second media data comes from an application running in the terminal device.

4. The method of claim 3, wherein the method is performed in a first application running in the terminal device, and obtaining the second media data by the second acquisition device of the terminal device comprises:
determining the application from at least one second application running at a client device; and
acquiring the second media data from the application.

5. The method of claim 4, wherein determining the application from the at least one second application running at the client device comprises:
providing at least one application identification of the at least one second application; and
determining the application in response to receiving a selection request for an application identification from the at least one application identification and based on the selection request.

6. The method of claim 4, wherein determining the application from the at least one second application running at the client device comprises:
generating a prompt for determining the application based on the first media data and the query; and
determining the application based on an answer for the prompt from the machine learning model.

7. The method of claim 4, wherein determining the application from the at least one second application running at the client device comprises:
determining a correlation between at least one of the first media data or the query and the at least one second application; and
determining the application from the at least one second application based on the correlation.

8. The method of claim 4, further comprising:
superimposing, in response to determining that a screen display interface of the terminal device is switched to the second application, a screen sharing representation on the screen display interface, the screen sharing representation indicating that the screen display interface is shared with the first application; and
superimposing a thumbnail representation of the first application on the screen display interface.

9. The method of claim 8, further comprising: switching the screen display interface of the terminal device to the first application in response to receiving an interaction request for the thumbnail representation.

10. The method of claim 1, wherein determining that the second media data needs to be obtained further comprises:
determining a correlation between the query and the first media data, in response to determining that a difference between an obtaining time of the first media data and an obtaining time of the query satisfies a predetermined time range; and
determining that the second media data needs to be obtained, in response to determining that the correlation satisfies a predetermined threshold condition.

11. The method of claim 10, further comprising: in response to determining that the correlation does not satisfy the predetermined threshold condition,
obtaining context data associated with the query based on an interaction history, the interaction history being an interaction history between a user providing the query and the terminal device; and
providing a reply for the query based on the context data.

12. The method of claim 1, further comprising:
obtaining context data associated with the query based on an interaction history, in response to determining that a difference between an obtaining time of the first media data and an obtaining time of the query does not satisfy a predetermined time range, the interaction history being an interaction history between a user providing the query and the terminal device;
determining a query intention based on the context data and the query; and
providing a reply for the query based on the query intention.

13. The method of claim 10, wherein determining the correlation between the query and the first media data comprises:
determining a text description of the first media data by using a machine learning model; and
determining the correlation based on the query and the text description.

14. An electronic device, comprising:
at least one processor; and
at least one memory, the at least one memory is coupled to the at least one processor, and stores instructions executable by the at least one processor, the instructions, when executed by the at least one processor, cause the electronic device to perform operations comprising:
obtaining first media data by a first acquisition device of a terminal device;
obtaining second media data by a second acquisition device of the terminal device, in response to determining that the second media data needs to be obtained, the determination being based on the first media data and a query; and
providing a reply for the query based on the first media data and the second media data.

15. The electronic device of claim 14, wherein providing the reply for the query comprises:
generating a prompt for processing the query based on the first media data, the second media data, and the query; and
providing the reply based on an answer for the prompt from a machine learning model.

16. The electronic device of claim 14, wherein the first media data comes from an external environment of the terminal device, and the second media data comes from an application running in the terminal device.

17. The electronic device of claim 16, wherein the method is performed in a first application running in the terminal device, and obtaining the second media data by the second acquisition device of the terminal device comprises:
determining the application from at least one second application running at a client device; and
acquiring the second media data from the application.

18. The electronic device of claim 17, wherein determining the application from the at least one second application running at the client device comprises:
providing at least one application identification of the at least one second application; and
determining the application in response to receiving a selection request for an application identification from the at least one application identification and based on the selection request.

19. The electronic device of claim 17, wherein determining the application from the at least one second application running at the client device comprises:
generating a prompt for determining the application based on the first media data and the query; and
determining the application based on an answer for the prompt from the machine learning model.

20. A non-transitory computer-readable storage medium storing a computer program, the computer program is executable by a processor to implement operations comprising:
obtaining first media data by a first acquisition device of a terminal device;
obtaining second media data by a second acquisition device of the terminal device, in response to determining that the second media data needs to be obtained, the determination being based on the first media data and a query; and
providing a reply for the query based on the first media data and the second media data.
